(19) United States
(12) Patent Application Publication
(10) Pub. No.: US 2019/0204131 A1
(43) Pub. Date: Jul. 4, 2019

(54) Apparatus and Method for Non-Invasive Fluid/Gas Flow Sensing in a Pipe

(71) Applicant: Wallflower Labs , Inc., Charlestown, MA (US)

(72) Inventors: Victor Roman Jablokov, Winchester, MA (US); Jeffrey Masters, Melrose, MA (US); Daniel Jay Kern, Cambridge, MA (US); Iain McDonald, Pittsford, NY (US)

(21) Appl. No.: 16/225,660

(22) Filed: Dec. 19, 2018

Related U.S. Application Data
(60) Provisional application No. 62/611,343, filed on Dec. 28, 2017.

(51) Int. Cl. G01F 1/684; F24C 3/12; G01K 1/14

(52) U.S. Cl. CPC G01F 1/6847; G01K 1/143; F24C 3/122

(57) ABSTRACT

A gas sensor that can clamp around a gas line to detect gas flow. The sensor can detect gas flow and notify other devices using wireless communication. Other conditions such as gas flow time, etc. can trigger notification. The sensor may also include a shut-off valve that can be controlled remotely or invoked under certain conditions.

### CROSS-REFERENCE TO RELATED APPLICATION

This application claims the benefit of priority of U.S. Provisional Patent Application No. 62/611,343, filed Dec. 28, 2017 and titled “Apparatus and Method for Non-Invasive Fluid/Gas Flow Sensing in a Pipe,” in the names of Victor Roman Jablokov, et al., which is herein incorporated by reference in its entirety.

### SUMMARY AND BACKGROUND

“Did I leave the stove on?” is a question that is firmly lodged in our collective consciousness. A need exists for a device to monitor a gas stove, determine if it is on or off, and be able to remotely report that information to a user.

The device described herein clamps around a user's gas line behind their stove—with no need to disconnect dangerous gas pipes.

Once the flow of gas is detected, the sensor can relay this information over the internet and notify a user's smartphone, tablet or computer. In addition, other conditions can be specified for alerting the user; for example, if the gas has been flowing for longer than a certain length of time.

Optionally, the device can include a shut-off valve, so that the flow of gas can be stopped either automatically under certain conditions or remotely by a user.

The fundamental sensing mechanism has applications far beyond the embodiment and application focused on here.

### BRIEF DESCRIPTION OF THE DRAWINGS

FIGS. 1-5 are drawings of a clamp mechanism according to embodiments of the present disclosure.

FIG. 6 is a chart illustrating a pipe temperature when a single stove burner is turned on and off.

FIG. 7 is a chart illustrating a pipe temperature when multiple stove burners are turned on and off.

FIG. 8 is a chart illustrating testing done to investigate steady-state temperature levels of different gas flow rates.

### DETAILED DESCRIPTION OF THE INVENTION

The present embodiment of the invention is a heater block with curved surface on one internal face of a clamp, and temperature sensors placed opposite to the heater block on the other side of the clamp. The clamp design allows for ease-of-installation on a pipe of interest.

A clamp is described with a central fulcrum. It is of a size that it can be actuated with one hand.

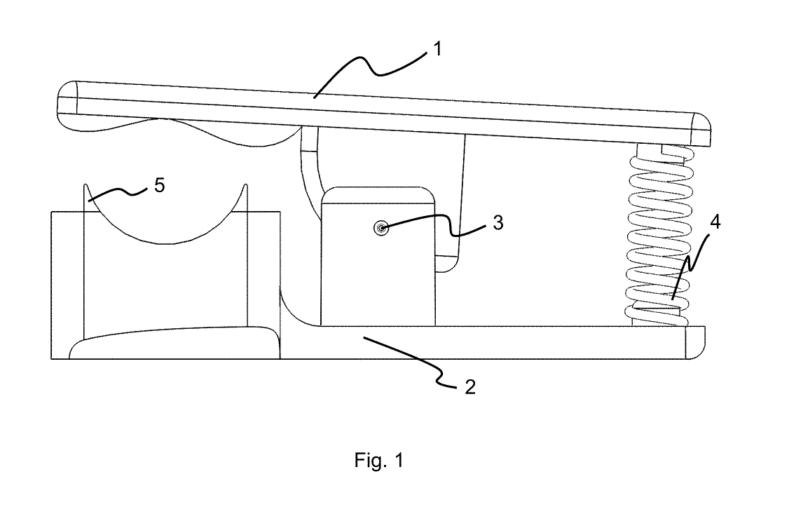

Referring now to the drawings, and specifically FIG. 1, the two clamp halves, 1 and 2, are shown to have a fulcrum at axle 3. Spring 4 biases the clamp to a closed position. Heater 5 is shown affixed to a section of clamp half 2.

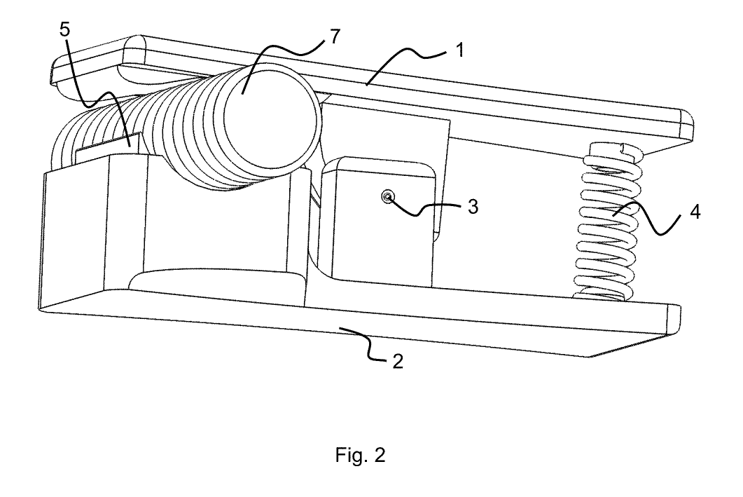

In FIG. 2, it can be seen that the curved surface of heater 5 accommodates a pipe 7—pictured as a section of corrugated stainless-steel pipe (known in the art as CSST). The CSST diameter can commonly vary between one-quarter of an inch and three-quarters of an inch; the clamp is sized to fit pipes of this range.

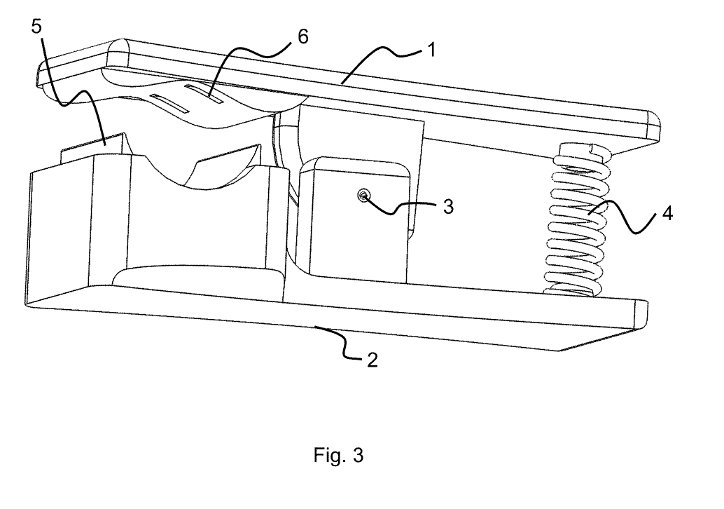

FIG. 3 is substantially the same as FIG. 2 with pipe 7 removed for clarity. In FIG. 3, it can be seen that the part of clamp half 1 which contacts the pipe has an area for temperature sensors 6.

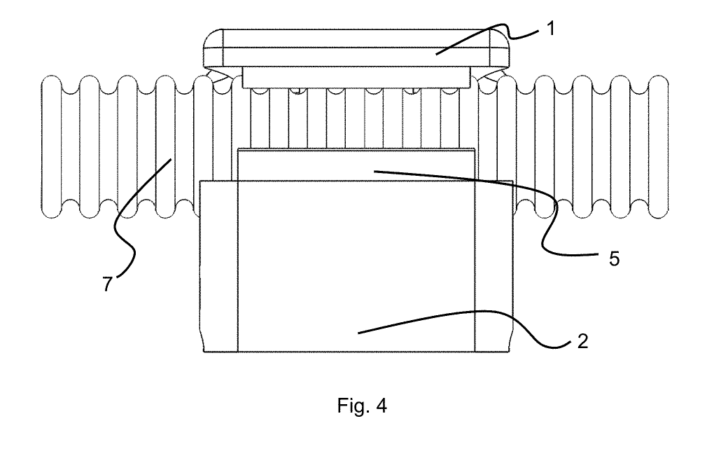

FIG. 4 is a front elevation view showing the in-use configuration with a section of CSST 7.

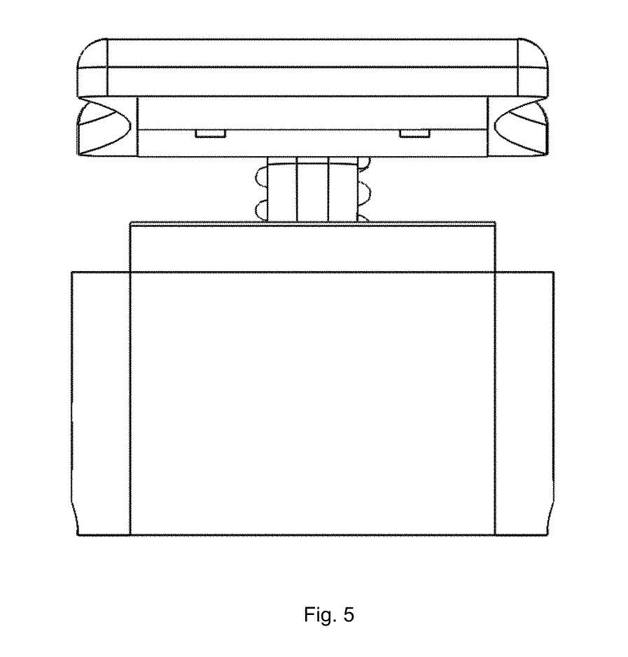

FIG. 5 is a front elevation view of the device in FIG. 3 with no CSST.

Other embodiments are possible, including a 2-piece toroidal clamp which is semi-permanently affixed to the pipe using screws or by other methods.

When the device is clamped on a pipe, the heater will impart heat directly to the pipe, and indirectly to any fluid/gas inside. In the present embodiment, the heat imparted to a ¾″ CSST pipe full of stationary air at standard temperature & pressure will increase the temperature of the pipe by a maximum of 15° F.

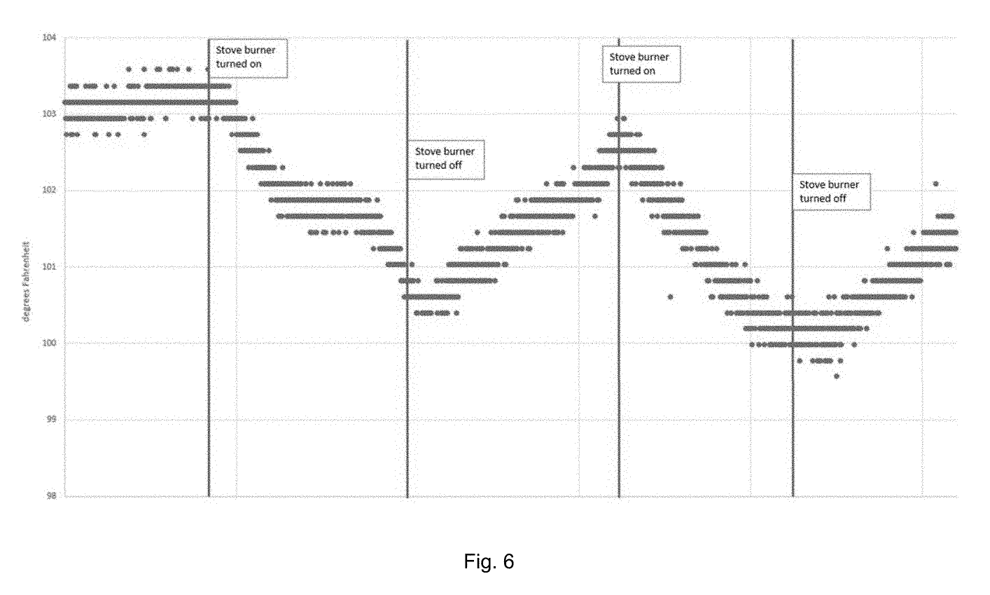

For example, if the invention is used for a residential gas stove, after the pipe reaches a steady-state temperature where the temperature of the pipe and the natural gas within the pipe is at a constant temperature, it becomes possible detect if the stove has turned on by sensing a sudden drop in pipe temperature when the gas commences flowing (see FIG. 6). FIG. 6 shows a simple test of a single stove burner turning on and off. For this test setup there is a steady-state outside pipe temperature of ^{˜}103 degrees F. A drop of about 2 degrees is seen each time the gas begins to flow through the pipe. Gas flow will cool the section of the pipe that was heated to a steady-state temperature nearly instantaneously, and by detecting the temperature drop we can infer that the gas stove has turned on. Conversely, when the gas knob is turned off and the natural gas ceases flowing, the temperature of the pipe will rise back to a steady-state temperature as the heater heats the pipe. When a temperature rise is measured, we can infer that the stove was turned off.

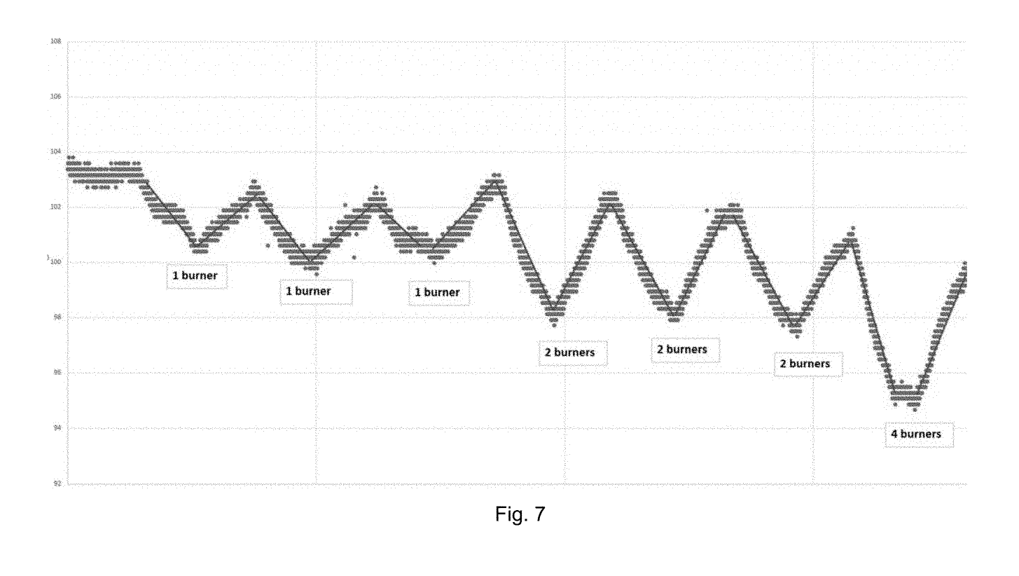

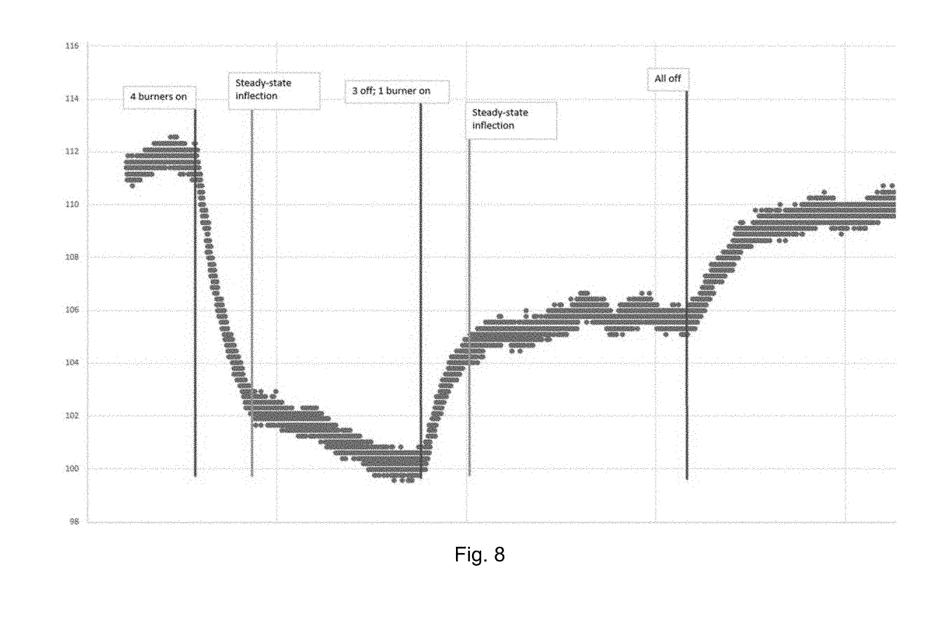

Additionally, in our residential gas stove example, the system is also sensitive enough to detect whether the stove knob is set to high or low (see FIGS. 7 and 8). FIG. 7 shows multi-burner testing. For three times in a row each, 1 and then 2 burners are turned on and off. FIG. 8 shows testing done to investigate steady-state temperature levels of different gas flow rates. This test used a warmer heating element than the first two, with a no-gas-flow steady-state temperature of about 112 degrees F. The test begins with 4 stove burners on and we immediately observe a steep slope and temperature drop then a steady-state period between 102 and 100 degrees F.; then, 3 burners are turned off, with 1 remaining on and we observe a temperature increase since the flow rate decreased until another steady-state temperature is reached at ^{˜}106 degrees F. Finally, the last burner is turned off and the temperature begins to increase back to the ^{˜}112 degrees F. where no burners are on.

When 2 burners are turned on, a steeper slope is observed for the temperature readings. This is due to the higher fluid flow rate in the pipe resulting in a quicker temperature drop in the pipe. When the stove knob is set to high to cook food quicker, there is a higher rate of gas flow so that the flame is larger, which the system detects as a higher cooling rate on the pipe. When the stove knob is set to a low setting, as in the case when simmering food using a smaller flame, there is less gas flow and a lower flow rate is measured by the system.

The fundamental sensing mechanism laid out here—of detecting fluid flow by means of monitoring the temperature of an externally-heated pipe—has applications far beyond the embodiment focused on here.

Once a condition of interest has been detected—either the start or end of fluid flow—the system can identify this and send it over Wi-Fi or another communications protocol to another device such as a server; from there, the information can be relayed to the user by way of their smartphone or other interface device.

In another embodiment of the invention, an electrically-actuated valve can be used to shut off gas flow; for example, if the user detects gas flowing when it may be unsafe, they can remotely shut off the gas flow.

What is claimed is:

1. An apparatus for detecting fluid flow comprising a temperature sensor on the outside of the pipe.

2. The apparatus of claim 1 wherein said apparatus is a clamp with temperature sensors to be attached to a pipe using spring force or semi-permanently affixed using screws.

3. The apparatus of claim 1 wherein said apparatus includes an electric heater to impart heat to the pipe and fluid/gas within the pipe.

4. The apparatus of claim 1 wherein said apparatus includes a microprocessor and radio transceiver to process data and communicate with a remote device.

5. A method for detecting fluid flow through a pipe by means of measuring temperature changes of the outside surface of the pipe when cooler gas and/or fluid begins to flow.

6. The method of claim 5 wherein an electric heater is used to impart heat to the pipe.
